(19) United States
(12) Patent Application Publication
(10) Pub. No.: US 2007/0079385 A1
(43) Pub. Date: Apr. 5, 2007

(54) Managing user permissions in a computer system

(75) Inventors: Jonathan Mark Alun Williams, Kidlington (GB); Edwin Paul Gibbons, Abingdon (GB); Geoffrey Hammond Soord, Radley (GB)

Correspondence Address: ARENT FOX PLLC, 1050 CONNECTICUT AVENUE, N.W., SUITE 400, WASHINGTON, DC, 20036, US

(73) Assignee: SOFTWARE 2000 LIMITED

(21) Appl. No.: 11/520,758

(22) Filed: Sep. 14, 2006

(30) Foreign Application Priority Data
Sep. 22, 2005 (GB) 0519266.1

(51) Int. Cl. H04L 9/32

(52) U.S. Cl. 726/27

(57) ABSTRACT

A method of operating a printer coupled to a computer, the method comprising associating one or more permissions of a printer driver resident on the computer with an operating system managed object and, when an attempt is made to print on said print device or a User Interface of the printer driver opened, setting the status of said permissions according to one or more security settings of the operating system managed object.

### FIELD OF THE INVENTION

The present invention relates to managing user permissions in a computer system and is applicable in particular, though not necessarily, to managing printing permissions at a user terminal, where user permissions may be any permission, privilege or right afforded to the user of the computer system.

### BACKGROUND TO THE INVENTION

In order to allow a client computer to make use of a printer, the client computer is typically provided with a printer driver which acts as interface between the application used to generate information to be printed and the printer. During printing operations, the role of the printer driver may be transparent to the user. Printer drivers are commonly provided with a user interface which allows the user some limited control over printing operations. In the case of a client computer using the Windows™ operating system, the printer driver user interfaces may be viewed by selecting the print option within an application and then selecting a specific printer, or by selecting preferences for a printer via the start menu.

In the case of a computer network such as a company LAN or WAN, a network administrator may want to limit the print options available to individual users. For example, for a given printer, the administrator may want to allow some users to be able to print in both colour and monochrome, whilst other users are restricted to printing only in monochrome. In the past, this flexibility has only been possible by providing different drivers to different users. However, this presents a headache for system administrators who much prefer a “one-model-fits-all” approach. In addition, such an approach does not allow user permissions to be modified in an easy and efficient manner.

Prior art approaches to printer control are considered in the following published documents; JP2002/149362, US2004/141203, US004/223182, EP0911723, U.S. Pat. No. 5,580,177, U.S. Pat. No. 6,396,594, US2001/030755, US2002/143773, US2003/112456, US2003/135549, US2004/017580, US2004/105112, US2004/125398, US2004/136023, US2004/227973, WO2004/084078, JP2003/228470, JP2004/021554, JP2004/334660, and JP2004/280227.

### SUMMARY OF THE INVENTION

According to a first aspect of the present invention there is provided a method of specifying and controlling user permissions for a software entity which can be run on a computer system, the method comprising associating one or more permissions of the software entity with an operating system managed object.

Embodiments of the present invention allow the status of a software entity permission, i.e. Allow or Deny, to be specified by appropriately setting user access permissions to the mapped operating system managed object.

Preferably, said operating system managed object is one of; pipes, queues, ports, flags, shared memory, files, directories. In the case where the object is a file, the user right used to specify the software entity permission is a read or read and execute right.

Said operating system managed object may comprise an extended existing manageable objects supported within the operating system, e.g. extension of Microsoft Windows ADS objects through updated schema, or the addition of Microsoft Windows ADAM objects to represent the permissions.

Preferably, said computer system is a client computer system coupled to a communication network, with the network being managed by a network server. The objects associated with the software entity permissions may be stored at the network server. Upon installation and/or use of the software entity, that entity may communicate with the network server to determine the status of a permission.

The status of a permission may control access to a function performed by the software entity. The status of a permission may determine the state of a User Interface for controlling the software entity. For example, the status of a permission may determine whether a button is selectable on a User Interface.

In one embodiment of the present invention said software entity is a printer driver. A permission may relate to one of; colour printing, overlay, watermarking.

According to a second aspect of the present invention there is provided a method of operating a printing device coupled to a computer system, the method comprising associating one or more permissions of a printer driver resident on the computer system with an operating system managed object and, when an attempt is made to print on said print device or a User Interface of the printer driver opened, setting the status of said permissions according to one or more security settings of the operating system managed object.

Said operating system managed object may be stored at a network server coupled to said computer system via a communications network. Said step of setting the status of said permission(s) comprises attempting to access said object from said computer system via said network. If the object can be accessed, the status of the permission is set to allowed. If the object cannot be accessed, the status of the permission is set to denied.

According to a third aspect of the present invention there is provided a computer programmed to implement the method of the above first or second aspects of the invention.

### BRIEF DESCRIPTION OF THE DRAWINGS

FIG. 1 shows a Windows printer driver UI for controlling overlay settings with full user permissions;

FIG. 2 shows a Windows printer driver UI for controlling overlay settings with partial user permissions;

FIG. 3 shows a Windows printer driver UI set for full colour printing;

FIG. 4 shows a Windows printer driver UI set for monochrome printing;

FIG. 5 illustrates schematically a conventional Windows printing process;

FIG. 6 illustrates schematically components involved in the process of FIG. 5;

FIG. 7 illustrates schematically a modified Windows printing process;

FIG. 8 illustrates schematically components involved in the process of FIG. 7;

FIG. 9 shows a Windows Internet Explorer panel displaying aliases operating system managed files corresponding to printer driver permissions; and

FIG. 10 shows a Windows Security tab for one of the files illustrated in the panel of FIG. 9.

### DETAILED DESCRIPTION OF CERTAIN EMBODIMENTS

A solution is presented here to the problem of allowing the control of printing options and is based upon a user permission system operated between the client terminal and a network operating system. The permission system extends the capability of the operating systems in a unique manner. It allows a printer supplier to define permissions that can be administered through the regular operating environment (whether Windows, Linux, BeOS, MacOS, Symbian operating systems or similar, Novell NetWare or an alternative solution). These permissions can determine for example whether or not certain items appear on the printer driver graphical user interface (UI) displayed on user terminals (even whether whole printer driver tabs are seen) and can also effect the hardware features that can be used by client terminals (colour printing or monochrome printing for example). The permissions also affect the device capabilities (“DevCaps”) reported to the operating system from the device driver—in this case the printer driver.

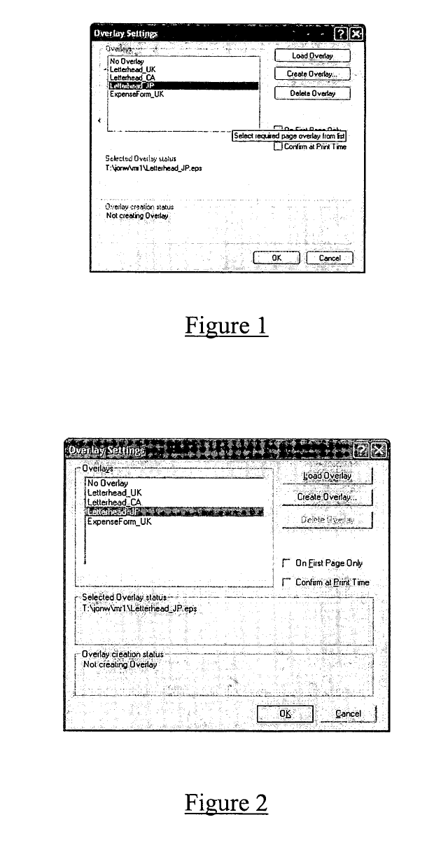

The permissions-based mechanism can manage the runtime use of data stored for driver use in an appropriate manner, including but not limited to overlay macros, watermarks, facsimiles, header pages, meta data such as job tickets, journal files, print files etc. Take as an example the case of an overlay function. Overlays are special “pages” of information that can be printed at the same time as a print job. A typical example is a letterhead overlay where the letterhead can be printed with a document without requiring a template in the word processor. Another example of the use of an overlay function is in form printing. The solution presented here allows control of users' permissions to use functions such as Use of Overlays, Creation of Overlays, and Deletion of Overlays. This might be achieved, for example, by disabling the overlay related buttons on the driver UI for users without the necessary permission. A user with full overlay permissions and print manager permission can create overlays, delete overlays and send overlays to a printer using a UI such as that illustrated in FIG. 1. FIG. 2 illustrates the UI available to another user who does not have permission to use the delete overlays option.

The solution can be used to manage access to data in a datastore used by the software. In this way access to certain overlays can, for example, be restricted to certain users only. The datastore can be located on the network or on local computers, and can be distributed across different locations. The solution proposed here will however manage the access from within the software.

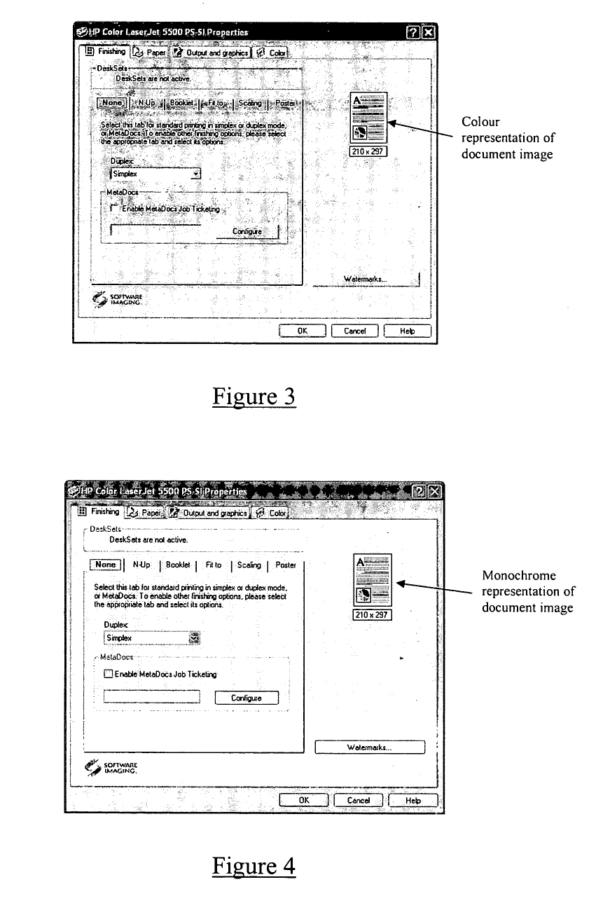

The solution presented here can be used on any printer related controls. This means “buttons” can be removed from the user interface based on user permissions (not just disabled as in the above example). An example is the use of colour where it is easy to restrict the use of colour to required access permissions such that the printer driver appears to be a colour driver to some users, as is illustrated in the sample UI of FIG. 3, while to others it appears as a monochrome driver, as illustrated in the sample UI of FIG. 4. Another function that can be controlled in a similar way is user access to watermarks.

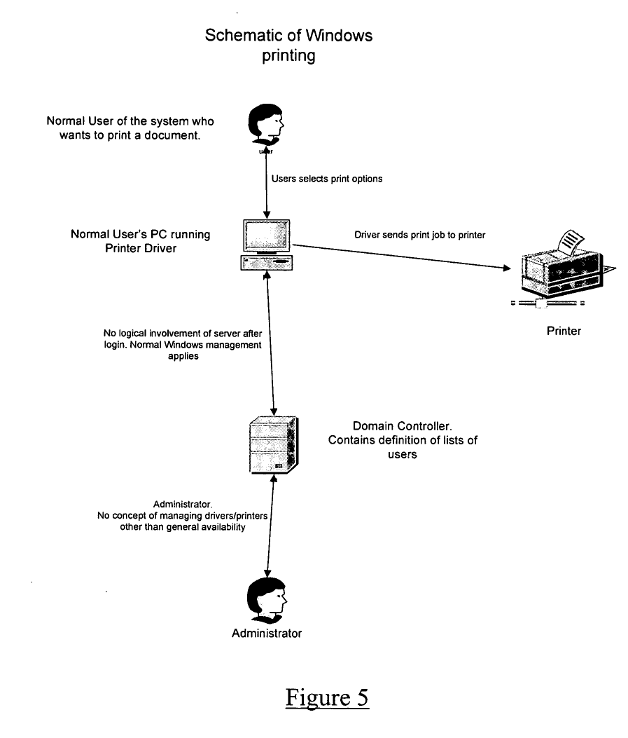

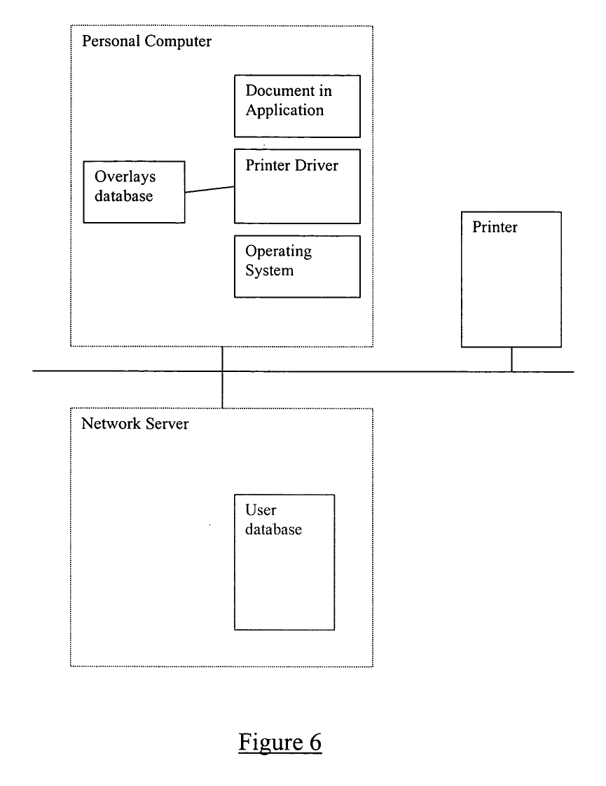

FIG. 5 illustrates schematically the prior art approach to network printing under a Windows environment. Once a driver is installed on a user's terminal (PC), when the user selects a print option there is no logical involvement of the server after login of the user to the network. The network administrator is not involved in managing drivers/printers other than controlling their general availability. This is illustrated further in the schematic of FIG. 6.

According to the solution presented here, the administration of permissions is carried out by the IT system administrator either using the UserGroup membership feature of Windows (NT and above) or Active Directory (ADS). In the case of ADS, an object will represent the driver (or group of drivers sharing the same permission definitions) and this object will have associated permissions, e.g. Access Watermarks dialog. The IT administrator can use ADS security tabs or the original equipment manufacturer (OEM) can supply custom tools to grant or deny these permissions to users and view existing permissions assignments. On other non-Windows systems such as Novell NetWare or Linux based systems, the extensions also work so this driver infrastructure is platform independent, and uses the operating system facilities to enable/deny permissions appropriately.

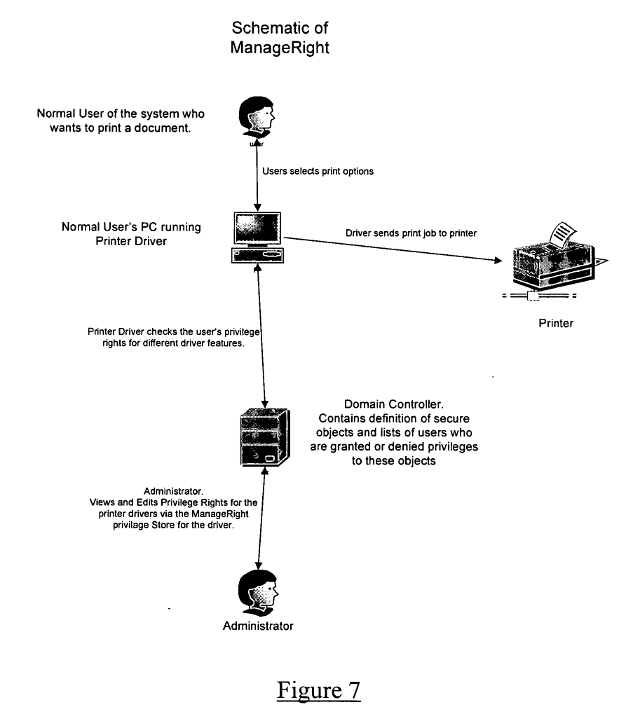

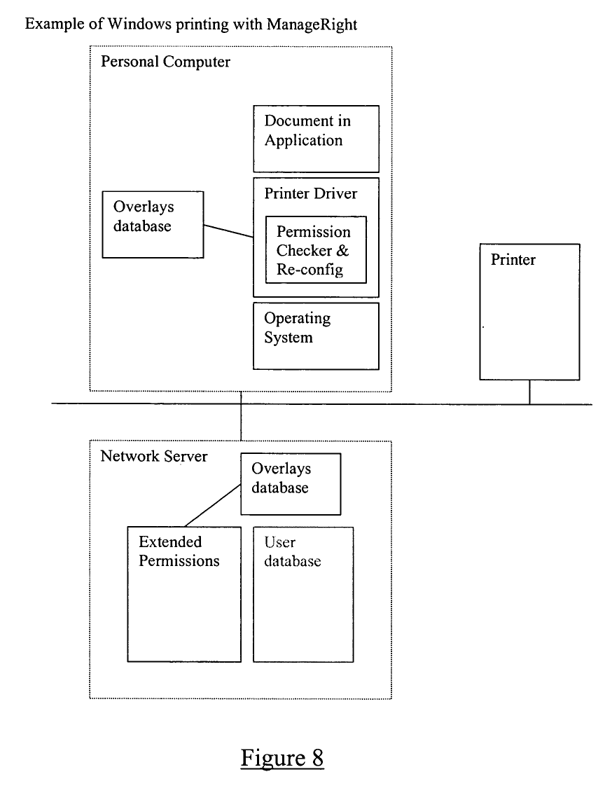

Turning now to FIG. 7, the modified approach to controlling user printer permissions is illustrated. When a user selects a print option (including actual printing and opening of a printer driver GUI), the printer driver communicates with the network server to determine appropriate permissions for the user. The GUI that is displayed to the user is configured according to the permissions returned by the server. This is illustrated further in the schematic of FIG. 8. The print job that is sent to the printer from the printer driver is constrained by the available permissions.

The creation and control of user permissions is facilitated by the use of operating system managed objects to provide access permissions to different functions and UI elements in computer software, such as in a printer driver or other software. Named permissions are effectively mapped to these objects. This allows any creatable operating system managed object to represent a named permission. Operating system managed objects include, for example; pipes, queues, ports, flags, shared memory, files, directories or other manageable objects. All of these objects have in common the fact that they possess a security property which can be managed by the network administrator. There is therefore no need to construct a custom database to manage permissions—these are available via pre-existing operating system mechanisms.

The required managed objects can be created by software developers using a suitable application programming interface (API). The objects are given names that are representative of the particular permission they represent (either directly or indirectly). Software running on a client terminal can read these permissions at runtime (in the case of a printer driver at print, display of user interface, or at other relevant event times for the printer driver) and modify its behaviour based on these permissions. The proposed solution extends the permissions available within an operating system based upon a software application's own design requirements, and is not limited by the operating system. That said, the existing operating system's permissions continue to work un-affected except where the software adds greater restrictions/access permissions.

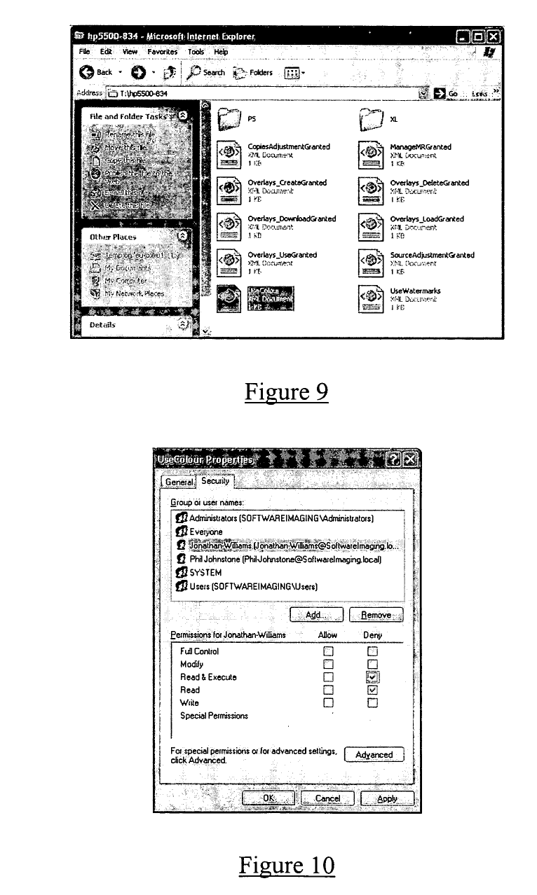

Typically, when a driver is first installed on a network server by the network administrator, the installation process will create for each permission an appropriately named object. These objects will typically be stored on the network server, although this need not be the case. Take as an example the scenario where the objects created by the API and mapped to respective permissions are files. FIG. 9 illustrates a number of such files, viewed in a Microsoft Internet Explorer panel, corresponding to usecolour, overlays_creategranted, etc, permissions. The Figure shows that the network administrator has selected the usecolour file. Under Windows O/S, to set the permissions for this file the administrator will right click on the selected file and select the “Properties” option. The administrator then selects the “Security” tab, and the panel shown in FIG. 10 is displayed. Individuals or groups of users attached to the network can be selected via the upper box of the displayed panel. The administrator then uses the “Allow” and “Deny” check boxes displayed in the lower box to set access permissions for users. More specifically, the “Read & Execute” “Allow” check box must be selected to grant permission to a user or user group.

When a driver is first installed on a client terminal, a list of required permissions are created and stored. The driver will then communicate with the network server to determine the state of each permission, as set by the network administrator. This checking merely involves the driver attempting to read a file mapped to a permission. If read access is allowed, the permission is considered granted. If, on the other hand, read access is denied, then the permission is considered denied.

As the solution uses an API to allow the managed objects to exist via the authentication system implemented for computer access, this means that with client based software such as Microsoft Windows printer drivers or applications, the software can be managed when using any number of different operating system environments on the server. For example a Novell NetWare or Unix-based user authentication system will also work using this invention.

The proposed solution can provide a level of off-line support through local “memory” of last-seen permissions, combined with “rules-of-life” of memorised permissions (i.e. a definition of “how long” non-connected permissions will be used for, after which period the driver/software will fall back to it's disconnected defaults). This allows for temporarily disconnected permissions-based management. Local “memory” can for example be registry-based data associated with the printer driver or other application software. The rules can allow for the driver/application software to fall-back to a specified default behaviour after some timeout period has elapsed, during which the driver has been unable to contact the network server

It will be appreciated by the person of skill in the art that various modifications may be made to the above described embodiments without departing from the scope of the present invention.

We claim:

1. A method of specifying and controlling user permissions for a software entity which can be run on a computer system, the method comprising associating one or more permissions of the software entity with an operating system managed object.

2. A method according to claim 1, wherein said permission is one of Allow or Deny.

3. A method according to claim 1 or 2, wherein said operating system managed object is one of; pipes, queues, ports, flags, shared memory, files, directories.

4. A method according to claim 1 or 2, wherein said operating system managed object is an extended existing manageable object supported within the operating system.

5. A method according to claim 1 or 2, wherein said operating system managed object is a file, and the user right of the file used to specify the software entity permission is a read or read and execute right.

6. A method according to claim 1, wherein said computer system is a client computer system coupled to a communication network, with the network being managed by a network server.

7. A method according to claim 6, wherein the operating system managed object associated with the software entity permission(s) is stored at the network server.

8. A method according to claim 7 and comprising, upon installation and/or use of the software entity, communicating between that entity and the network server to identify to the software entity the status of a permission.

9. A method according to claim 1, wherein the status of a permission, controls access to a function performed by the software entity.

10. A method according to claim 1, wherein the status of a permission determines the state of a User Interface for controlling the software entity.

11. A method according to claim 1, wherein the status of a permission determines the access right(s) to particular data in a datastore for use by the software entity.

12. A method according to claim 1, wherein the status of a permission determines the access right(s) to particular data in a datastore for controlling the software entity.

13. A method according to claim 1, wherein the status of a permission determines the access right(s) to create, manage, or access particular data in a datastore.

14. A method according to claim 1, wherein said software entity is a printer driver.

15. A method according to claim 14, wherein said computer system is coupled to a printing device controlled by the printer driver.

16. A method according to claim 1, wherein said software entity is a management application.

17. A method of operating a printing device coupled to a computer system, the method comprising associating one or more permissions of a printer driver resident on the computer system with an operating system managed object and, when an attempt is made to print on said print device or a User Interface of the printer driver opened, setting the status of said permissions according to one or more security settings of the operating system managed object.

18. A method according to claim 17, wherein said operating system managed object is stored at a network server coupled to said computer system via a communications network.

19. A method according to claim 18, wherein said step of setting the status of said permission(s) comprises attempting to access said object from said computer system via said network, and, if the object can be accessed, the status of the permission is set to allowed, and, if the object cannot be accessed, the status of the permission is set to denied.

20. A computer programmed to implement the method of claim 1 or 17.
